(19) United States
(12) Patent Application Publication
(10) Pub. No.: US 2023/0410016 A1
(43) Pub. Date: Dec. 21, 2023

(54) METHODS AND SYSTEMS OF FACILITATING PROVISIONING CONTEXTS FOR BUSINESS SITUATIONS USING A SEMANTIC GRAPH

(71) Applicant: Narrative BI Inc, Middletown, DE (US)

(72) Inventors: Aliaksei Vertsel, REDWOOD CITY, CA (US); Valiantsin Zavadski, Montijo (PT); Yury Koleda, Mazowieckie (PL); Mikhail Rumiantsau, San Francisco, CA (US)

(73) Assignee: Narrative BI Inc, Middletown, DE (US)

(21) Appl. No.: 18/240,421

(22) Filed: Aug. 31, 2023

(51) Int. Cl. G06Q 10/0637

(52) U.S. Cl. CPC G06Q 10/0637

(57) ABSTRACT

Disclosed herein is a method of facilitating provisioning contexts for business situations. Accordingly, the method may include receiving at least one business dataset associated with a business organization in real time from a device, analyzing the at least one business dataset, extracting a plurality of business events from the at least one business dataset based on the analyzing of the at least one business dataset, analyzing the plurality of business events, determining a plurality of business insights from the plurality of business events using the event assessment algorithm, analyzing the plurality of business insights, determining at least one connection between at least two of the plurality of business insights, constructing a semantic graph for providing a context for each of at least one business situation associated with the business organization, and storing the semantic graph.

### FIELD OF THE INVENTION

Generally, the present disclosure relates to the field of data processing. More specifically, the present disclosure relates to methods and systems of facilitating provisioning contexts for business situations using a semantic graph.

### BACKGROUND OF THE INVENTION

The field of data processing is technologically important to several industries, business organizations, and/or individuals. In particular, the use of data processing is prevalent for facilitating provisioning contexts for business situations.

In a data-driven economy, organizations often face the problem of data overload, where the massive amounts of available data create great potential for accurate and profound decision-making, yet make it difficult to focus on the relevant fragments of data and turn the data into actionable insights. Existing techniques for facilitating provisioning contexts for business situations are deficient with regard to several aspects. For instance, current technologies for automated data systems generating actionable insights are based on structured data sets via complex logical rules and statistical algorithms. Furthermore, current technologies do not generate individual narratives expressing the insights in an intuitive human-readable form. Further, individual insights often lack the necessary context for optimal decision-making support. Moreover, current technologies do not provide additional insights that create a holistic view of the business situation.

Therefore, there is a need for improved methods and systems of facilitating provisioning contexts for business situations using a semantic graph that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating provisioning contexts for business situations, in accordance with some embodiments. Accordingly, the method may include receiving, using a communication device, at least one business dataset associated with a business organization in real time from at least one device. Further, the method may include analyzing, using a processing device, the at least one business dataset. Further, the method may include extracting, using the processing device, a plurality of business events from the at least one business dataset based on the analyzing of the at least one business dataset. Further, the plurality of business events may be characterized by at least one business field. Further, the method may include analyzing, using the processing device, the plurality of business events. Further, the method may include determining, using the processing device, a plurality of business insights from the plurality of business events based on the analyzing of the plurality of business events. Further, the method may include analyzing, using the processing device, the plurality of business insights. Further, the method may include determining, using the processing device, at least one connection between at least two of the plurality of business insights based on the analyzing of the plurality of business insights. Further, the at least one connection links at least two of the plurality of business insights. Further, the method may include constructing, using the processing device, a semantic graph for providing a context for each of at least one business situation associated with the business organization based on the plurality of business insights and the at least one connection between at least two of the plurality of business insights. Further, the semantic graph represents each of the plurality of business insights as a node and each of the at least one connection as an edge linking at least two nodes of a plurality of nodes corresponding to the plurality of business insights. Further, the semantic graph provides the context for the business situation. Further, the method may include storing, using a storage device, the semantic graph.

Further disclosed herein is a system of facilitating provisioning contexts for business situations, in accordance with some embodiments. Accordingly, the system may include a communication device configured for receiving at least one business dataset associated with a business organization in real time from at least one device. Further, the system may include a processing device communicatively coupled with the communication device. Further, the processing device may be configured for analyzing the at least one business dataset. Further, the processing device may be configured for extracting a plurality of business events from the at least one business dataset based on the analyzing of the at least one business dataset.Further, the plurality of business events may be characterized by at least one business field. Further, the processing device may be configured for analyzing the plurality of business events. Further, the processing device may be configured for determining a plurality of business insights from the plurality of business events based on the analyzing of the plurality of business events. Further, the processing device may be configured for analyzing the plurality of business insights. Further, the processing device may be configured for determining at least one connection between at least two of the plurality of business insights based on the analyzing of the plurality of business insights. Further, the at least one connection links at least two of the plurality of business insights. Further, the processing device may be configured for constructing a semantic graph for providing a context for each of at least one business situation associated with the business organization based on the plurality of business insights and the at least one connection between at least two of the plurality of business insights. Further, the semantic graph represents each of the plurality of business insights as a node and each of the at least one connection as an edge linking at least two nodes of a plurality of nodes corresponding to the plurality of business insights. Further, the semantic graph provides the context for the business situation. Further, the system may include a storage device communicatively coupled with the processing device. Further, the storage device may be configured for storing the semantic graph.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flow chart of a method 200 of facilitating provisioning contexts for business situations, in accordance with some embodiments.

FIG. 3 is a flow chart of a method 300 of facilitating provisioning contexts for business situations, in accordance with some embodiments.

FIG. 4 is a flow chart of a method 400 of facilitating provisioning contexts for business situations, in accordance with some embodiments.

FIG. 5 is a flow chart of a method 500 of facilitating provisioning contexts for business situations, in accordance with some embodiments.

FIG. 6 is a flow chart of a method 600 of facilitating provisioning contexts for business situations, in accordance with some embodiments.

FIG. 7 is a flow chart of a method 700 of facilitating provisioning contexts for business situations, in accordance with some embodiments.

FIG. 8 is a flow chart of a method 800 of facilitating provisioning contexts for business situations, in accordance with some embodiments.

FIG. 9 is a flow chart of a method 900 of facilitating provisioning contexts for business situations, in accordance with some embodiments.

FIG. 10 is a block diagram of a system 1000 of facilitating provisioning contexts for business situations, in accordance with some embodiments.

FIG. 11 is a block diagram of the system 1000 of facilitating provisioning contexts for business situations, in accordance with some embodiments.

FIG. 12 is a flow diagram of a method 1200 for facilitating showing states of processed data from a structured data set to business insights to a semantic graph based on data processing, in accordance with some embodiments.

FIG. 13 is a schematic of a semantic graph 1300 for facilitating provisioning contexts for business situations, in accordance with some embodiments.

FIG. 14 is a schematic of a user interface (UI) layout 1400 for facilitating provisioning contexts for business situations, in accordance with some embodiments.

FIG. 15 is a screenshot of a user interface 1500 illustrating connection embeddings for facilitating provisioning contexts for business situations, in accordance with some embodiments.

FIG. 16 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems of facilitating provisioning contexts for business situations, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems of facilitating provisioning contexts for business situations. The disclosed system is configured for generating a semantic graph that addresses the context problem. The semantic graph is a network of connectors that link individual business insights, thus providing a more comprehensive context for each business situation. Further, the disclosed system also introduces a user-friendly, intuitive UI for navigating the semantic graph, which enables optimal exploration of vast amounts of structured business data.

Further, the disclosed system may be associated with a business event that may be any change in business metrics within a specific period of time found in a structured data set. Further, the disclosed system may be configured for determining a business insight that may include a business event that passes the importance criteria as defined by an assessment algorithm. Further, in the semantic graph, every individual business event may be presented as a node linked to other nodes via connectors of various types. Further, the connectors may include but are not limited to cause-effect, temporal, hierarchal, dimensional (geo, demography), and similarity.

The information stored in the semantic graph (or graph) may be used for visualization of individual nodes and their linked neighbors as well as for dynamic navigation.

Further, the semantic graph may include UI elements for the graph visualization and navigation. Further, the UI elements may include a customizable feed, a main node view, connection embeddings (such as individual links, link lists, graph-based text description, text embeddings, and chart embeddings), and transition types (such as full jump and quick view).

Further, the semantic graph allows external events (proprietary and outside the company) to be linked into the graph. Further, the disclosed system may be configured for saving exploration paths history to further use in personalized navigation recommendations

Further, the business event (or events) which serve as the nodes of the semantic graph disclosed here may be structured objects defined by a list of fields (name-value pairs).

Further, a full structure of the business event object and 2 exemplary embodiments are disclosed for describing the semantic graph principles. Further, required fields may include a start period, an end period, a metric, a metric value for the start period, a metric value for the end period, a type of change (increase or decrease), and a percent of change. Further, the semantic graph may be associated with optional fields such as dimension and dimension value. Further, a length of a period may vary from one millisecond to one year (or even longer), depending on the nature of the observed data. If the length of a period in the event object is different from the data granularity of the data set, an aggregation function needs to be applied to the data (usually average or sum).

Further, in an exemplary embodiment, a generic event (empty dimension) may be:

| Metric | number of users |
|---|---|
| Start period | Feb. 19, 2023 |
| End period | Feb. 20, 2023 |
| Start period value | 69 |
| End period value | 107 |
| Type of change | Increase |
| Percent of change | 55% |

Further, in a second exemplary embodiment, a second event with a dimension (country) may be:

| Metric | number of page views |
|---|---|
| Dimension | Country |
| Dimension value | Germany |
| Start period | Feb. 19, 2023 |
| End period | Feb. 20, 2023 |
| Start period value | 14000 |
| End period value | 7000 |
| Type of change | decrease |
| Percent of change | 50% |

Further, the semantic graph may include graph connectors. Further, types of graph connectors associated with the semantic graph may be:
1. Cause-effect: The disclosed system may be configured for identifying cause-effect relations in structured data. Essentially, two events may be connected by the relation of causality, i.e. if one event directly or indirectly triggers the other event. Related link symbols: causes, caused_by.
2. Temporal: This type of connector may link events based on their temporal proximity or sequence. Further, events occurring close in time or forming a chronologically sequenced series can be linked, offering a time-based context for understanding the evolution of certain metrics or occurrences. Related link symbols: preceded_by, followed_by, next_day, previous_day, next_week, etc.
3. Hierarchical: Hierarchical connectors establish links based on parent-child relations, i.e., from general to specific or vice versa or terms of UI navigation—drill down. An example of such a connector may be a transition from total revenue for the day to revenue by a specific product. In case business events have several associated dimensions (e.g., revenues for the combination of age and country are known), the graph may be used to arrange sequential drill downs, e.g., from total sales->to sales in the USA->to sales in the USA, age 25-35. Related link symbols: drill_down_to_{dimension}, drill_up, etc.
4. Dimensional (geo, demography, etc.): Dimensional connectors introduce variables to the interconnected events related to geographical, demographical, categorical, or basically any imaginable feature relevant to the business domain in question. These links add an additional layer of context and as opposed to the previous section (Hierarchical connector), the dimensional connectors present the peer-to-peer horizontal links that allow transitions, e.g., from one country to another, or from one metric to another metric within the same country. Related link symbols: has_the_same_dimension, has_the_same_metric, etc.
5. Similarity: Similarity connectors link events that have similar levels of business importance as reflected by the percent of the metric value change (refer to event object structure). The association of this kind may be more loose and less obvious but can drive out-of-the-box analysis on the pointed-out events. Related symbols: is_close_to.

Further, the user interface presents various elements that enable intuitive exploration and understanding of the semantic graph. Further, the user interface may include a customizable event feed that serves as a personalized dashboard that displays insights relevant to the user's preferences and operational needs, including the time period settings as well as the preferred metrics and dimension settings. The feed basically acts as the entry point into the graph pointing out the most prominent events worth paying primary attention to.

Further, the user interface may be associated with a main node view that allows the users to dive deep into a particular insight, exploring its detailed properties, related insights, and the nature of their interconnections.

Further, the user interface may include connection embeddings. Further, connection links may be represented in multiple ways, such as individual links or link lists. Moreover, the connections may be embedded in text descriptions generated based on the graph structure, or as text and chart embeddings within a node view.

Further, the user interface (UI) supports two primary modes of transitioning between nodes: ‘Full jump’ which completely redirects the user to a new node, and ‘Quick view’ which provides an overlay or an overlay window with a brief overview of the linked node, maintaining the user's current context.

Further, the disclosed system may support external events integration. Further, external events, both proprietary and those occurring outside the company, may be integrated into the semantic graph. This broadens the range of contextual factors considered and enables a more holistic understanding of business dynamics.

The disclosed system preserves the history of exploration paths, recording the sequence of nodes visited by the user. These recorded paths may later be utilized to provide personalized navigation recommendations, optimizing the user's journey through the graph based on their past behavior and preferences.

Further, the present disclosure describes a system for generating a semantic graph connecting actionable insights derived from structured business data. Further, the system comprises a data processing unit configured to analyze structured business data and extract business events, each business event is defined by a set of required fields comprising start period, end period, metric, metric value for the start period, metric value for the end period, type of change, and percent of change, and optionally one or more dimensions. Further, the system may include an event assessment algorithm to identify business insights from the business events based on predefined importance criteria. Further, the system may include a graph generation module configured to construct a semantic graph, wherein each node in the graph represents a business insight and edges represent connections between the insights based on one or more of the following criteria: cause-effect, temporal, hierarchical, dimensional, and similarity. Further, the system may include a user interface module presenting a main node view, a customizable event feed, and a variety of ways to visualize and navigate connections between nodes including individual links, link lists, graph-based text descriptions, text embeddings, and chart embeddings. Further, the system may include a transition module within the user interface module, supporting full jump and quick view transitions between nodes. Further, the system may include an external event integration module, capable of incorporating external events into the semantic graph. Further, the system may include a user navigation tracking module, capable of recording the user's path through the semantic graph and utilizing it for personalized navigation recommendations.

Further, the business events may be observed facts or facts and the business insights may be a subset of priority observed facts or facts that may be identified based on a plurality of priority factors associated with each observed fact. Each priority factor may be a value assigned to the observed fact and may be derived from data within the observed fact, or may be separately assigned, for example, based on the column of the data set associated with the observed fact. This is based on the principle that not all the facts about the changes in metrics are significant enough to be taken into account in the decision making process. Further, the business insight may be a subset of priority observed facts that pass the importance criteria as defined by the event assessment algorithm The event assessment algorithm takes the following priority factors into account when measuring the priority of an observed fact which may be the business events:
(1) Percent of change: where larger changes are assigned a higher priority than observed facts having smaller changes (the percent of change, as shown above, is a field in the observed facts in some embodiments);
(2) Value range coefficient: with larger absolute numbers, the importance of facts becomes more sensitive to the percent of change (e.g. on a website with 1M visitors, a 10% daily increase [which would mean +100K users] will be considered an important event, while jumping from 100 to 200 users is a lot more likely and therefore less important [even though formally it's a significant 100% increase]; this may be accounted for by, for example, setting a value range coefficient to 0.2 for the value range of 0-1000, 0.3 for the range of 1000-10,000, etc.);
(3) Metric importance coefficient: some metrics are more sensitive to change than others, and may be pre-assigned an importance coefficient increasing the likelihood of being selected as a. priority observed fact,
(4) Dimension importance coefficient: certain dimension labels, like country or age, can be weighted as having a higher priority than other dimension labels associated with the observed facts;
(5) Dimension value importance coefficient: certain dimension values can be configured to be more important, (e.g., the United States and Germany can be configured to be the most important countries when associated with observed facts). In some embodiments, all coefficient values used to determine fact priority may be numbered in the range from 0 to 1. Also, in some embodiments, the overall observed fact priority may be captured by a fact significance score associated with each observed fact. This may be calculated, for example, by multiplying the change value with all the coefficients: Overall fact significance is Overall Change value*Value range coefficient*Metric importance coefficient*Dimension importance coefficient*Dimension value importance coefficient

In other embodiments, fewer or more coefficients may be used to determine the fact significance scores for each observed fact. The priority observed facts may be selected based on the fact significance scores, where a predetermined N number of facts are selected or may be selected based on having greater than a predetermined threshold priority value, in various embodiments. The N number can be configured empirically depending on the size of data source and/or user preferences.

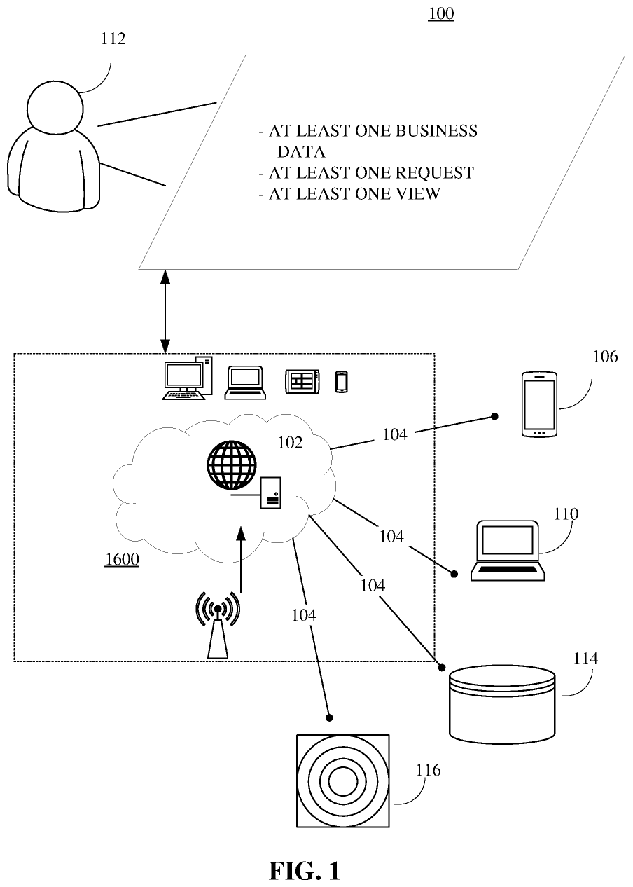

FIG. 1 is an illustration of an online platform 100 consistent with various embodiments of the present disclosure. By way of non-limiting example, the online platform 100 for facilitating provisioning contexts for business situations may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1600.

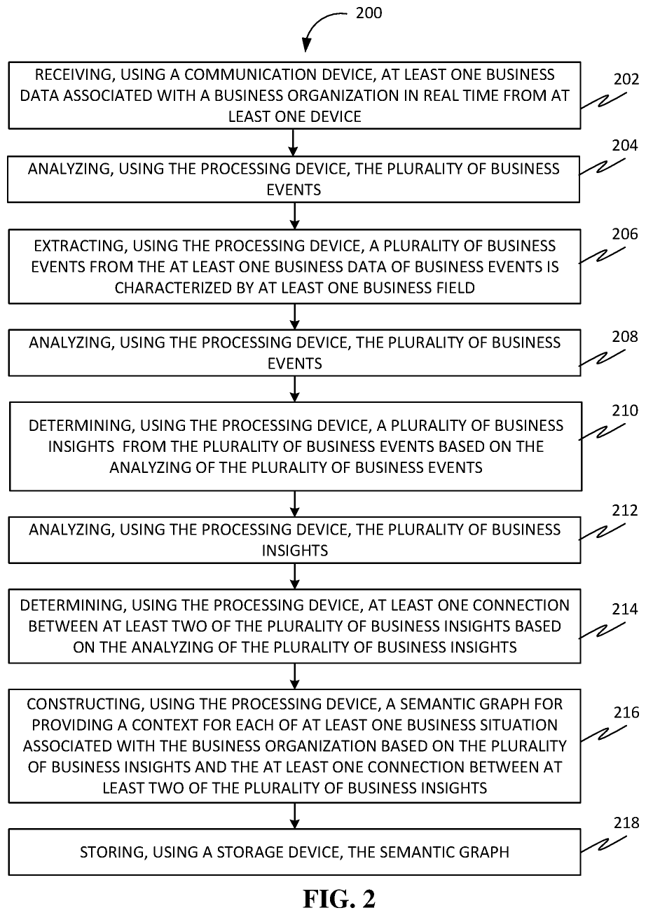

FIG. 2 is a flow chart of a method 200 of facilitating provisioning contexts for business situations, in accordance with some embodiments. Accordingly, at 202, the method 200 may include receiving, using a communication device (such as a communication device 1002), at least one business dataset associated with a business organization in real time from at least one device (such as at least one device 1102). Further, the at least one device may be at least one sensor. Further, the at least one sensor may be configured for detecting at least one value of at least one of an internal condition and an external condition associated with the business organization in real time for generating the at least one business dataset. Further, the internal condition may include internal environmental conditions (such as temperature, humidity, lighting, air quality, noise level, energy usage, etc.), movement, occupancy, etc., associated with facilities (such as an office, warehouse, server rooms, etc.) associated with the business organization. Further, the external condition may include external environmental conditions (such as temperature, humidity, lighting, air quality, noise level, energy usage, etc.), customer footfall associated with facilities (such as an office, warehouse, server rooms, etc.) associated with the business organization, asset proximity associated with the facilities. Further, the at least one sensor may include an environmental sensor, a motion sensor, a location sensor, etc. Further, the at least one device may be configured for continuously collecting the at least one business dataset in real time. Further, the at least one business dataset may include a structured dataset. Further, the at least one business dataset may include text data, image data, sensor data, etc. Further, the at least one business dataset may include business events feed. Further, in an embodiment, the at least one device may be a server hosting at least one application associated with the business organization. Further, the server may be configured for continuously collecting at least one information associated with a sale duration, a number of clicks, a number of page views, etc. associated with the at least one application for generating the at least one business dataset. Further, the business organization may be a client. Further, the at least one business dataset may be client data. Further, the at least one device may include a client device, a smartphone, a tablet, a laptop, a server, a mobile, a sensor, and so on. Further, at 204, the method 200 may include analyzing, using a processing device (such as a processing device 1004), the at least one business dataset. Further, at 206, the method 200 may include extracting, using the processing device, a plurality of business events from the at least one business dataset based on the analyzing of the at least one business dataset. Further, the plurality of business events may be characterized by at least one business field. Further, in an instance, the at least one business field may include a start period, an end period, a business metric, a business metric value for the start period, a business metric value for the end period, a type of change, and a percent of change. Further, the at least one business field may include one or more dimensions. Further, the plurality of business events may include any change in a plurality of business metrics within a specific period of time found in the at least one business dataset. Further, the plurality of business events may be structured objects defined by fields (name-value pairs). Further, at 208, the method 200 may include analyzing, using the processing device, the plurality of business events. Further, at 210, the method 200 may include determining, using the processing device, a plurality of business insights from the plurality of business events based on the analyzing of the plurality of business events. Further, at 212, the method 200 may include analyzing, using the processing device, the plurality of business insights. Further, at 214, the method 200 may include determining, using the processing device, at least one connection between at least two of the plurality of business insights based on the analyzing of the plurality of business insights. Further, the determining of the at least one connection may include determining the at least one connection in real time. Further, the at least one connection may be connectors, graph connectors, etc. Further, the at least one connection links at least two of the plurality of business insights. Further, at 216, the method 200 may include constructing, using the processing device, a semantic graph for providing a context for each of at least one business situation associated with the business organization based on the plurality of business insights and the at least one connection between at least two of the plurality of business insights. Further, the constructing of the semantic graph may include constructing the semantic graph in real time. Further, the at least one business situation may be a change in conditions associated with the business organization. Further, the semantic graph represents each of the plurality of business insights as a node and each of the at least one connection as an edge linking at least two nodes of a plurality of nodes corresponding to the plurality of business insights. Further, the semantic graph provides the context for the business situation. Further, the context may be a causal context, a time based context, a hierarchical context, a dimensional context, a similarity context, etc. based on the at least one connection between at least two of the plurality of nodes. Further, the causal context may include a first node of the plurality of nodes, which is caused, by a second node of the plurality of nodes, a first node of the plurality of nodes, which is resulted, in a second node of the plurality of nodes, etc. Further, the time based context may include a first node of the plurality of nodes, which is preceded, by a second node of the plurality of nodes, a first node of the plurality of nodes, which is followed, by a second node of the plurality of nodes, etc. Further, the similarity context may include a first node of the plurality of nodes which is similar to a second node of the plurality of nodes, etc. Further, a type of the at least one connection between at least two of the plurality of nodes describes the context. Further, at 218, the method 200 may include storing, using a storage device (such as a storage device 1006), the semantic graph.

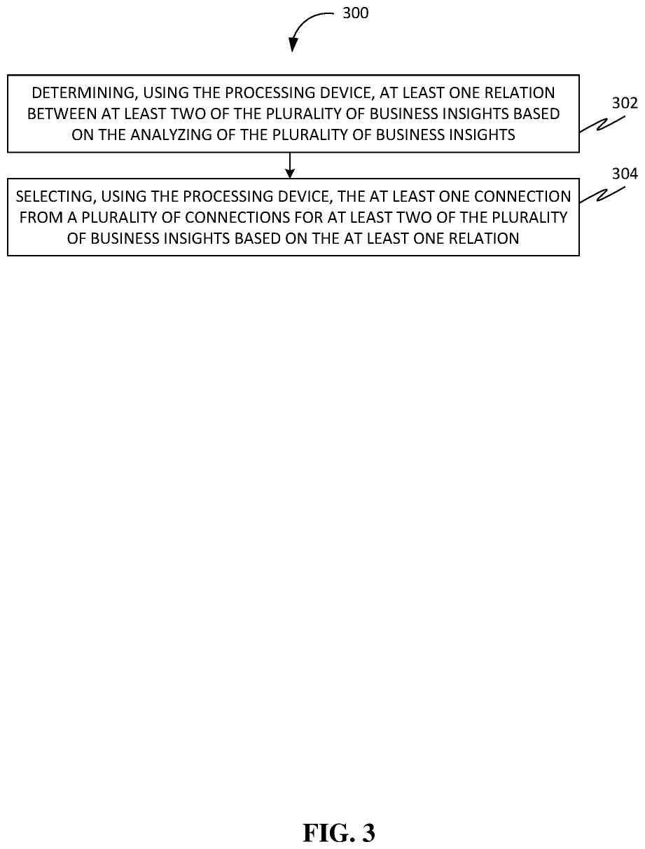

FIG. 3 is a flow chart of a method 300 of facilitating provisioning contexts for business situations, in accordance with some embodiments. Accordingly, at 302, the method 300 may include determining, using the processing device, at least one relation between at least two of the plurality of business insights based on the analyzing of the plurality of business insights. Further, the at least one relation may include a cause effect relation, a chronological relation, a parent child relation, etc. Further, the at least one connection may include a cause-effect connection, a temporal connection, a hierarchal connection, a dimensional (geographical demographical, etc.) connection, and a similarity connection. Further, at 304, the method 300 may include selecting, using the processing device, the at least one connection from a plurality of connections for at least two of the plurality of business insights based on the at least one relation. Further, the determining of the at least one connection between the at least two of the plurality of business insights may be based on the selecting.

Further, in some embodiments, the analyzing of the plurality of business events may include analyzing the plurality of business events using an event assessment algorithm. Further, the event assessment algorithm applies at least one predefined importance criteria for identifying the plurality of business insights from the plurality of business events. Further, the determining of the plurality of business insights may be based on the identifying.

Further, in some embodiments, the method 200 may include determining, using the processing device, at least one additional connection between at least two of the plurality of business events based on the analyzing of the plurality of business events. Further, the at least one additional connection links at least two of the plurality of business events. Further, the plurality of business events may include the plurality of business insights. Further, the constructing of the semantic graph may be based on the plurality of business events and the at least one additional connection linking at least two of the plurality of business events. Further, the semantic graph represents each of the plurality of business events as an additional node and each of the at least one additional connection as an additional edge linking at least two additional nodes of a plurality of additional nodes corresponding to the plurality of business events.

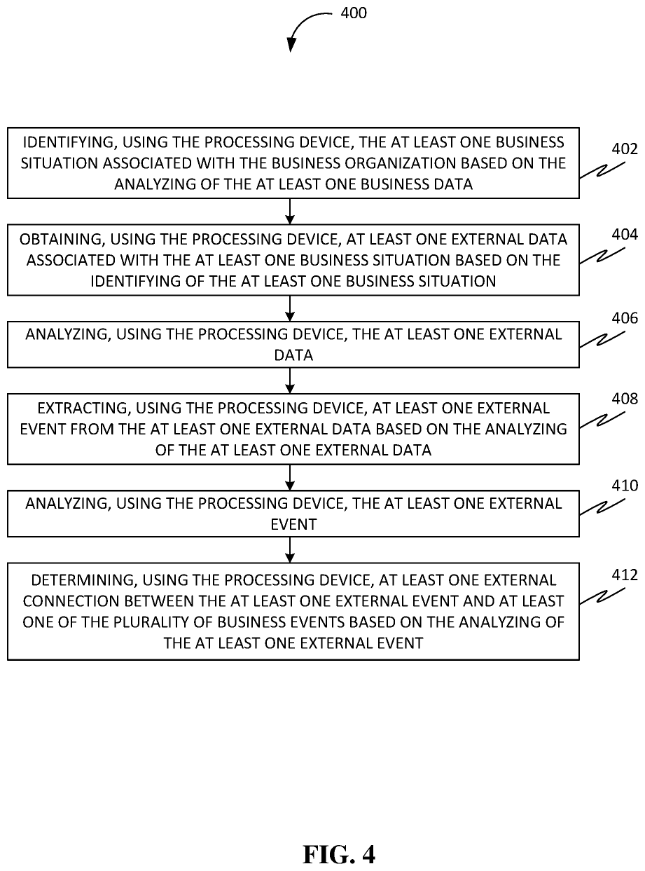

FIG. 4 is a flow chart of a method 400 of facilitating provisioning contexts for business situations, in accordance with some embodiments. Accordingly, at 402, the method 400 may include identifying, using the processing device, the at least one business situation associated with the business organization based on the analyzing of the at least one business dataset. Further, at 404, the method 400 may include obtaining, using the processing device, at least one external data associated with the at least one business situation based on the identifying of the at least one business situation. Further, at 406, the method 400 may include analyzing, using the processing device, the at least one external data. Further, at 408, the method 400 may include extracting, using the processing device, at least one external event from the at least one external data based on the analyzing of the at least one external data. Further, the at least one external event may include events that may be proprietary and outside the business organization. Further, at 410, the method 400 may include analyzing, using the processing device, the at least one external event. Further, at 412, the method 400 may include determining, using the processing device, at least one external connection between the at least one external event and at least one of the plurality of business events based on the analyzing of the at least one external event. Further, in an embodiment, the at least one external connection may include a cause-effect connection, a temporal connection, a hierarchal connection, a dimensional connection, and a similarity connection. Further, the at least one external connection links the at least one external event and at least one of the plurality of business events. Further, the constructing of the semantic graph may be based on the at least one external event, at least one of the plurality of business events, and the at least one external connection linking the at least one external event and at least one of the plurality of business events. Further, the semantic graph represents each of the at least one external event as an external node, at least one of the plurality of business events as an additional node, and each of the at least one external connection as an external edge linking at least one external node corresponding to the at least one external event and at least one of a plurality of additional nodes corresponding at least one of the plurality of business events.

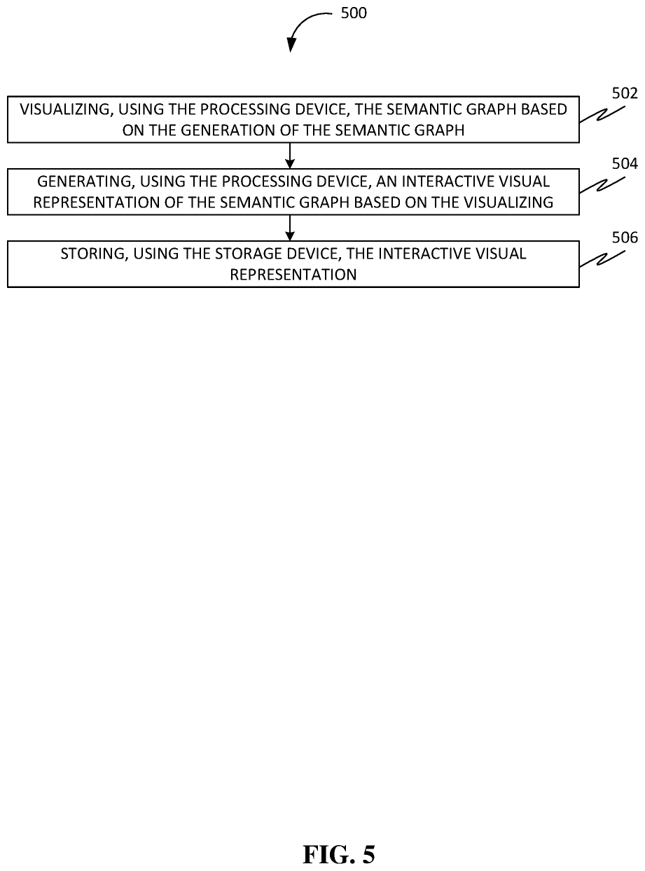

FIG. 5 is a flow chart of a method 500 of facilitating provisioning contexts for business situations, in accordance with some embodiments. Accordingly, at 502, the method 500 may include visualizing, using the processing device, the semantic graph based on the generation of the semantic graph. Further, at 504, the method 500 may include generating, using the processing device, an interactive visual representation of the semantic graph based on the visualizing. Further, the interactive visual representation allows exploring of the semantic graph. Further, at 506, the method 500 may include storing, using the storage device, the interactive visual representation.

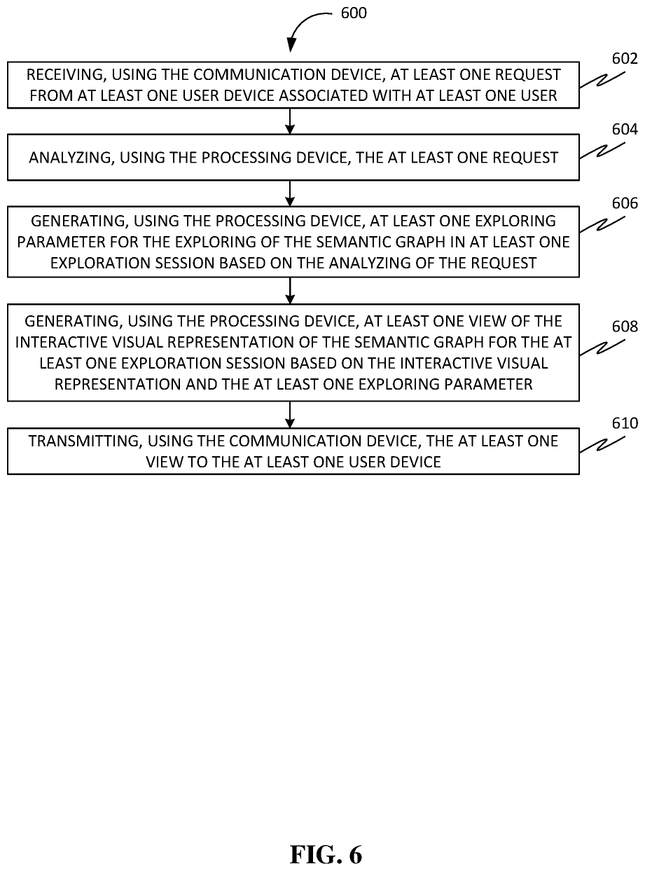

FIG. 6 is a flow chart of a method 600 of facilitating provisioning contexts for business situations, in accordance with some embodiments. Accordingly, at 602, the method 600 may include receiving, using the communication device, at least one request from at least one user device (such as at least one user device 1104) associated with at least one user. Further, the at least one user device may include a smartphone, a tablet, a laptop, a server, a personal computer, and so on. Further, the at least one request may include a user command for navigating and exploring the semantic graph. Further, in an instance, the user command may indicate that the at least one user may want to explore and navigate from a first business insight of the plurality of business insights to a second business insight of the plurality of business insights through the at least one connection related to the context. Further, the first business insight corresponds to a first node of the plurality of nodes and the second business insight corresponds to a second node of the plurality of nodes. Further, at 604, the method 600 may include analyzing, using the processing device, the at least one request. Further, at 606, the method 600 may include generating, using the processing device, at least one exploring parameter for the exploring of the semantic graph in at least one exploration session based on the analyzing of the at least one request. Further, the at least one exploration parameter may include a time period, a metric, a dimension, etc. for selecting one or more nodes. Further, the one or more nodes may be identified from the plurality of nodes based on the at least one exploration parameter. Further, at 608, the method 600 may include generating, using the processing device, at least one view of the interactive visual representation of the semantic graph for the at least one exploration session based on the interactive visual representation and the at least one exploring parameter. Further, the at least one view may include at least a portion of the interactive visual representation including the one or more nodes and one or more connections associated with the one or more nodes. Further, in some embodiments, the at least one view may include a main node view, an event detailed view, and a connected event detailed view. Further, in some embodiments, the at least one view may include connection embeddings and a customizable event feed. Further, at 610, the method 600 may include transmitting, using the communication device, the at least one view to the at least one user device.

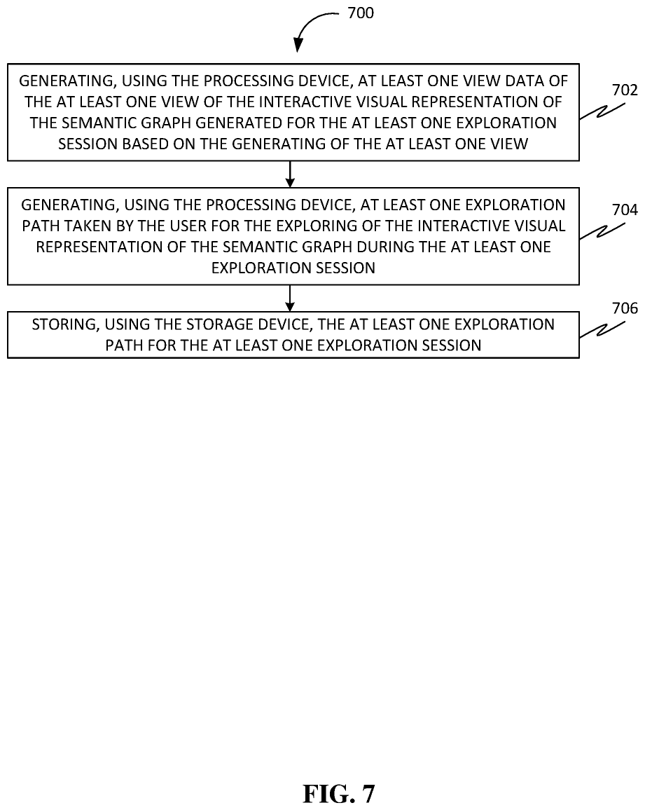

FIG. 7 is a flow chart of a method 700 of facilitating provisioning contexts for business situations, in accordance with some embodiments. Accordingly, at 702, the method 700 may include generating, using the processing device, at least one view data of the at least one view of the interactive visual representation of the semantic graph generated for the at least one exploration session based on the generating of the at least one view. Further, the at least one view data may include one or more views of the interactive visual representation, a visiting/exploring of the one or more nodes in the one or more views, etc. Further, at 704, the method 700 may include generating, using the processing device, at least one exploration path taken by the at least one user for the exploring of the interactive visual representation of the semantic graph during the at least one exploration session. Further, the at least one exploration path may include a trail or sequence of the plurality of business insights or the plurality of nodes corresponding to the plurality of business insights visited or explored by the at least one user in the at least one exploration session. Further, at 706, the method 700 may include storing, using the storage device, the at least one exploration path for the at least one exploration session.

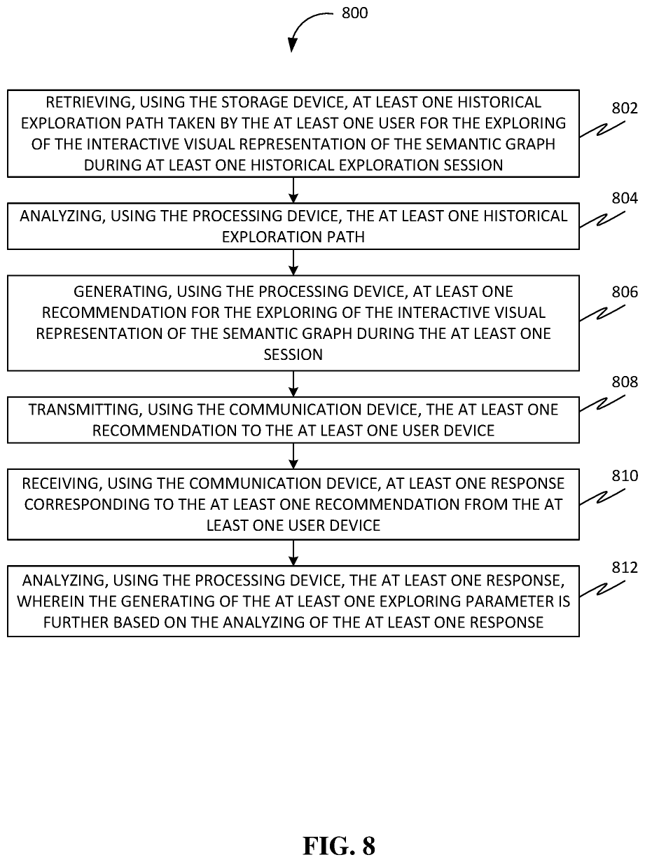

FIG. 8 is a flow chart of a method 800 of facilitating provisioning contexts for business situations, in accordance with some embodiments. Accordingly, at 802, the method 800 may include retrieving, using the storage device, at least one historical exploration path taken by the at least one user for the exploring of the interactive visual representation of the semantic graph during at least one historical exploration session. Further, at 804, the method 800 may include analyzing, using the processing device, the at least one historical exploration path. Further, at 806, the method 800 may include generating, using the processing device, at least one recommendation for the exploring of the interactive visual representation of the semantic graph during the at least one exploration session. Further, at 808, the method 800 may include transmitting, using the communication device, the at least one recommendation to the at least one user device. Further, at 810, the method 800 may include receiving, using the communication device, at least one response corresponding to the at least one recommendation from the at least one user device. Further, at 812, the method 800 may include analyzing, using the processing device, the at least one response. Further, the generating of the at least one exploring parameter may be based on the analyzing of the at least one response. Further, the at least one recommendation may include a personalized navigation recommendation for optimizing a journey of the at least one user through the semantic graph based on their past behavior and preferences comprised in the at least one historical exploration path.

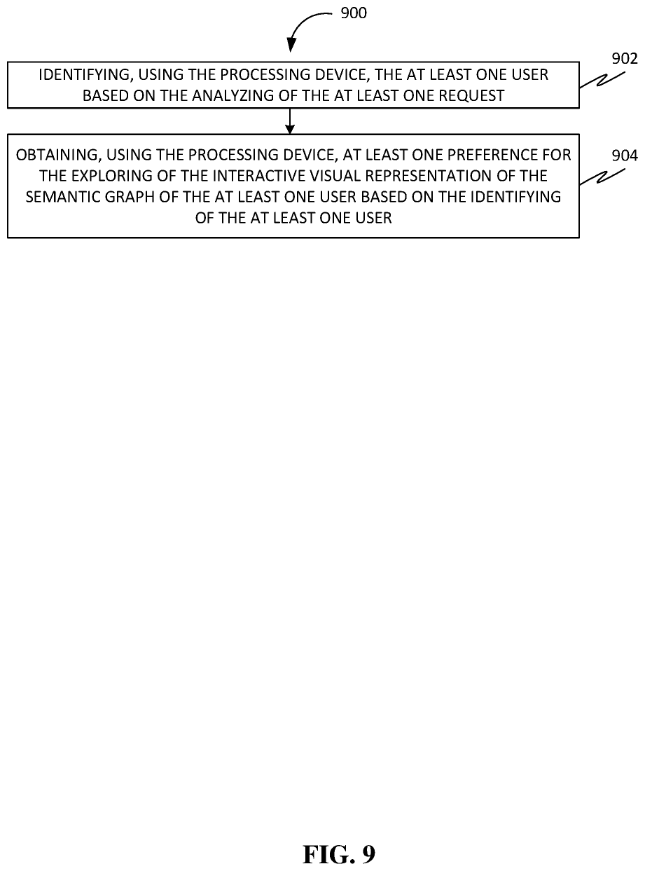

FIG. 9 is a flow chart of a method 900 of facilitating provisioning contexts for business situations, in accordance with some embodiments. Accordingly, at 902, the method 900 may include identifying, using the processing device, the at least one user based on the analyzing of the at least one request. Further, at 904, the method 900 may include obtaining, using the processing device, at least one preference for the exploring of the interactive visual representation of the semantic graph of the at least one user based on the identifying of the at least one user. Further, the generating of the at least one exploring parameter may be based on the at least one preference.

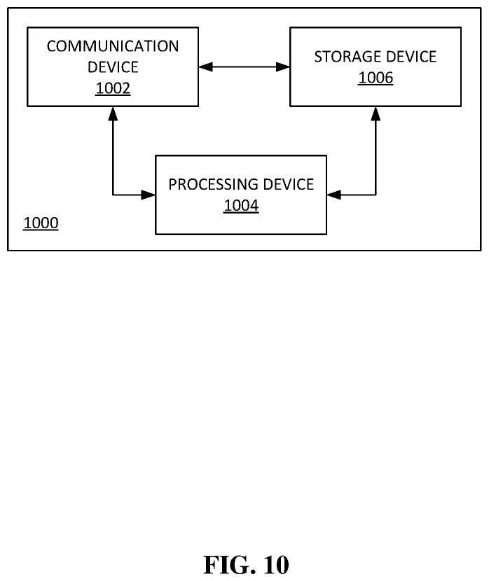

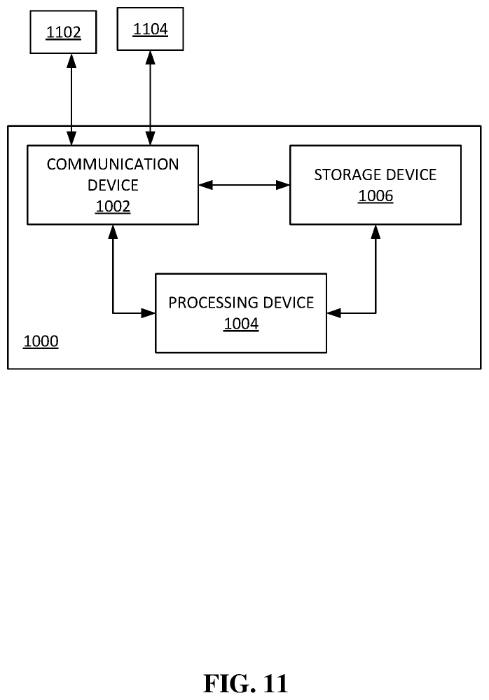

FIG. 10 is a block diagram of a system 1000 of facilitating provisioning contexts for business situations, in accordance with some embodiments. Accordingly, the system 1000 may include a communication device 1002 configured for receiving at least one business dataset associated with a business organization in real time from at least one device 1102 (as shown in FIG. 11). Further, the at least one device 1102 may be at least one sensor. Further, the at least one sensor may be configured for detecting at least one value of at least one of an internal condition and an external condition associated with the business organization in real time for generating the at least one business dataset. Further, the system 1000 may include a processing device 1004 communicatively coupled with the communication device 1002. Further, the processing device 1004 may be configured for analyzing the at least one business dataset. Further, the processing device 1004 may be configured for extracting a plurality of business events from the at least one business dataset based on the analyzing of the at least one business dataset. Further, the plurality of business events may be characterized by at least one business field. Further, the processing device 1004 may be configured for analyzing the plurality of business events. Further, the processing device 1004 may be configured for determining a plurality of business insights from the plurality of business events based on the analyzing of the plurality of business events. Further, the processing device 1004 may be configured for analyzing the plurality of business insights. Further, the processing device 1004 may be configured for determining at least one connection between at least two of the plurality of business insights based on the analyzing of the plurality of business insights. Further, the at least one connection links at least two of the plurality of business insights. Further, the processing device 1004 may be configured for constructing a semantic graph for providing a context for each of at least one business situation associated with the business organization based on the plurality of business insights and the at least one connection between at least two of the plurality of business insights. Further, the semantic graph represents each of the plurality of business insights as a node and each of the at least one connection as an edge linking at least two nodes of a plurality of nodes corresponding to the plurality of business insights. Further, the semantic graph provides the context for the business situation.

Further, the system 1000 may include a storage device 1006 communicatively coupled with the processing device 1004. Further, the storage device 1006 may be configured for storing the semantic graph.

Further, in some embodiments, the processing device 1004 may be configured for determining at least one relation between at least two of the plurality of business insights based on the analyzing of the plurality of business insights. Further, the processing device 1004 may be configured for selecting the at least one connection from a plurality of connections for at least two of the plurality of business insights based on the at least one relation. Further, the determining of the at least one connection between the at least two of the plurality of business insights may be based on the selecting.

Further, in some embodiments, the analyzing of the plurality of business events may include analyzing the plurality of business events using an event assessment algorithm. Further, the event assessment algorithm applies at least one predefined importance criteria for identifying the plurality of business insights from the plurality of business events. Further, the determining of the plurality of business insights may be based on the identifying.

Further, in some embodiments, the processing device 1004 may be configured for determining at least one additional connection between at least two of the plurality of business events based on the analyzing of the plurality of business events. Further, the at least one additional connection links at least two of the plurality of business events. Further, the plurality of business events may include the plurality of business insights. Further, the constructing of the semantic graph may be based on the plurality of business events and the at least one additional connection linking at least two of the plurality of business events. Further, the semantic graph represents each of the plurality of business events as an additional node and each of the at least one additional connection as an additional edge linking at least two additional nodes of a plurality of additional nodes corresponding to the plurality of business events.

Further, in some embodiments, the processing device 1004 may be configured for identifying the at least one business situation associated with the business organization based on the analyzing of the at least one business dataset. Further, the processing device 1004 may be configured for obtaining at least one external data associated with the at least one business situation based on the identifying of the at least one business situation. Further, the processing device 1004 may be configured for analyzing the at least one external data. Further, the processing device 1004 may be configured for extracting at least one external event from the at least one external data based on the analyzing of the at least one external data. Further, the processing device 1004 may be configured for analyzing the at least one external event. Further, the processing device 1004 may be configured for determining at least one external connection between the at least one external event and at least one of the plurality of business events based on the analyzing of the at least one external event. Further, the at least one external connection links the at least one external event and at least one of the plurality of business events. Further, the constructing of the semantic graph may be based on the at least one external event, at least one of the plurality of business events, and the at least one external connection linking the at least one external event and at least one of the plurality of business events. Further, the semantic graph represents each of the at least one external event as an external node, at least one of the plurality of business events as an additional node, and each of the at least one external connection as an external edge linking at least one external node corresponding to the at least one external event and at least one of a plurality of additional nodes corresponding at least one of the plurality of business events.

Further, in some embodiments, the processing device 1004 may be configured for visualizing the semantic graph based on the generation of the semantic graph. Further, the processing device 1004 may be configured for generating an interactive visual representation of the semantic graph based on the visualizing. Further, the interactive visual representation allows exploring of the semantic graph. Further, the storage device 1006 may be configured for storing the interactive visual representation.

Further, in some embodiments, the communication device 1002 may be configured for receiving at least one request from at least one user device 1104 (as shown in FIG. 11) associated with at least one user. Further, the communication device 1002 may be configured for transmitting at least one view to the at least one user device 1104. Further, the processing device 1004 may be configured for analyzing the at least one request. Further, the processing device 1004 may be configured for generating at least one exploring parameter for the exploring of the semantic graph in at least one exploration session based on the analyzing of the at least one request. Further, the processing device 1004 may be configured for generating the at least one view of the interactive visual representation of the semantic graph for the at least one exploration session based on the interactive visual representation and the at least one exploring parameter.

Further, in some embodiments, the processing device 1004 may be configured for generating at least one view data of the at least one view of the interactive visual representation of the semantic graph generated for the at least one exploration session based on the generating of the at least one view. Further, the processing device 1004 may be configured for generating at least one exploration path taken by the at least one user for the exploring of the interactive visual representation of the semantic graph during the at least one exploration session. Further, the storage device 1006 may be configured for storing the at least one exploration path for the at least one exploration session.

Further, in some embodiments, the storage device 1006 may be configured for retrieving at least one historical exploration path taken by the at least one user for the exploring of the interactive visual representation of the semantic graph during at least one historical exploration session. Further, the processing device 1004 may be configured for analyzing the at least one historical exploration path. Further, the processing device 1004 may be configured for generating at least one recommendation for the exploring of the interactive visual representation of the semantic graph during the at least one exploration session. Further, the processing device 1004 may be configured for analyzing at least one response. Further, the generating of the at least one exploring parameter may be based on the analyzing of the at least one response. Further, the communication device 1002 may be configured for transmitting the at least one recommendation to the at least one user device 1104. Further, the communication device 1002 may be configured for receiving the at least one response corresponding to the at least one recommendation from the at least one user device 1104.

Further, in some embodiments, the processing device 1004 may be configured for identifying the at least one user based on the analyzing of the at least one request. Further, the processing device 1004 may be configured for obtaining at least one preference for the exploring of the interactive visual representation of the semantic graph of the at least one user based on the identifying of the at least one user. Further, the generating of the at least one exploring parameter may be based on the at least one preference.

FIG. 11 is a block diagram of the system 1000 of facilitating provisioning contexts for business situations, in accordance with some embodiments.

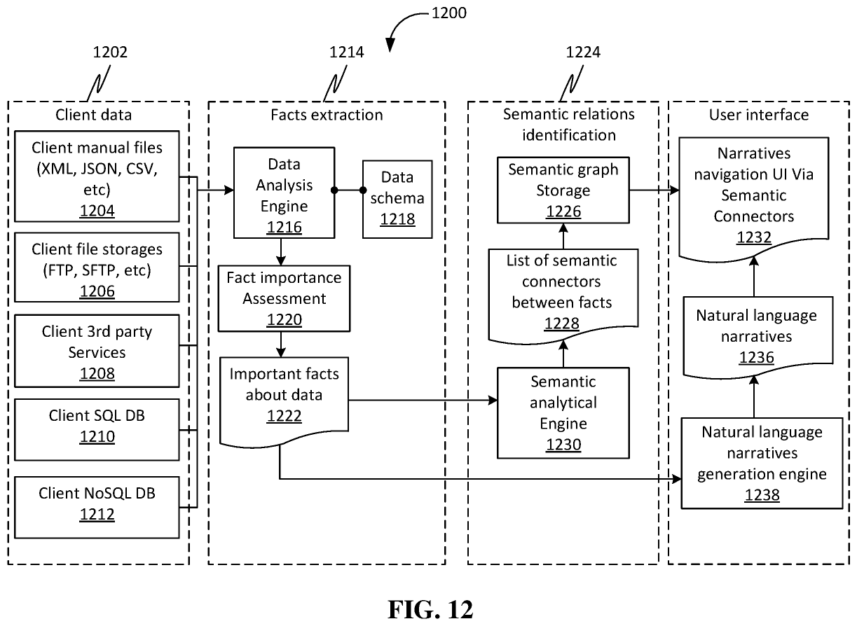

FIG. 12 is a flow diagram of a method 1200 for facilitating showing states of processed data from a structured data set to business insights to a semantic graph based on data processing, in accordance with some embodiments. Accordingly, at 1202, the method 1200 may include receiving a client data. Further, the client data may include client manual files 1204, client file storages 1206, client 3^{rd} party services 1208, client SQL DB 1210, and a client NoSQL DB 1212. Further, at 1214, the method 1200 may include performing facts extraction. Further, the facts extraction may be performed by a data analysis engine 1216. Further, the facts extraction may be associated with a data schema 1218. Further, at 1220, the data analysis engine 1216 may be configured for performing fact importance assessment. Further, at 1222, the method 1200 may include generating important facts about data. Further, at 1224, the method 1200 may include identifying semantic relations. Further, at 1228, the method 1200 may include determining a list of semantic connectors between facts by a semantic analytical engine 1230. Further, at 1226, the method 1200 may include storing a semantic graph. Further, at 1236, the method 1200 may include a natural language narratives generation engine 1238 generating natural language narratives. Further, the natural language narratives generation engine 1238 may receive the important facts about data. Further, at 1232, the method 1200 may include generating a narratives navigation user interface via semantic connectors.

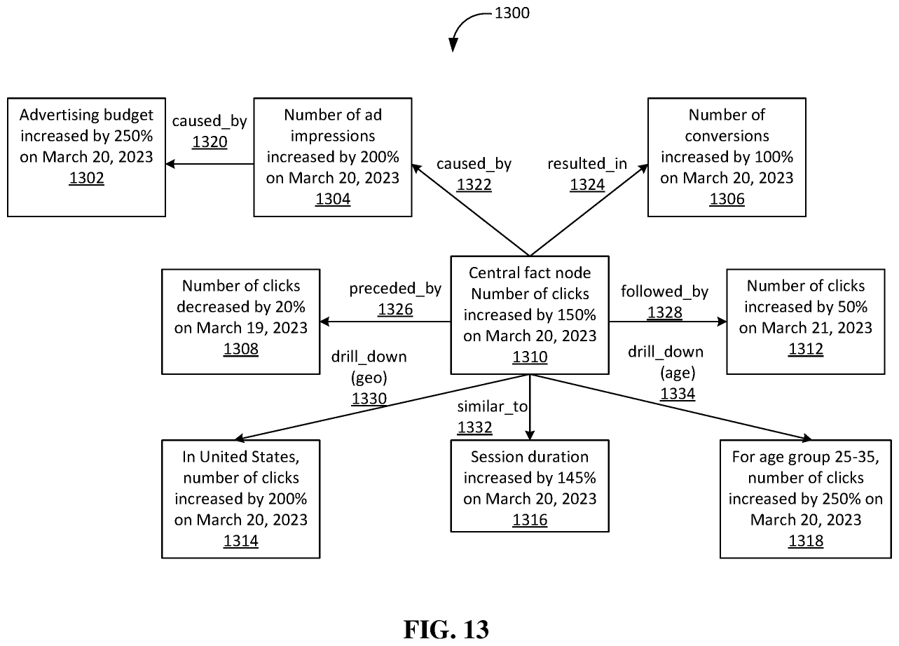

FIG. 13 is a schematic of a semantic graph 1300 for facilitating provisioning contexts for business situations, in accordance with some embodiments. Accordingly, the semantic graph 1300 may include nodes 1302-1318 representing business events and edges 1320-1334 showing the different types of connections such as cause-effect, temporal, hierarchical, dimensional, and similarity.

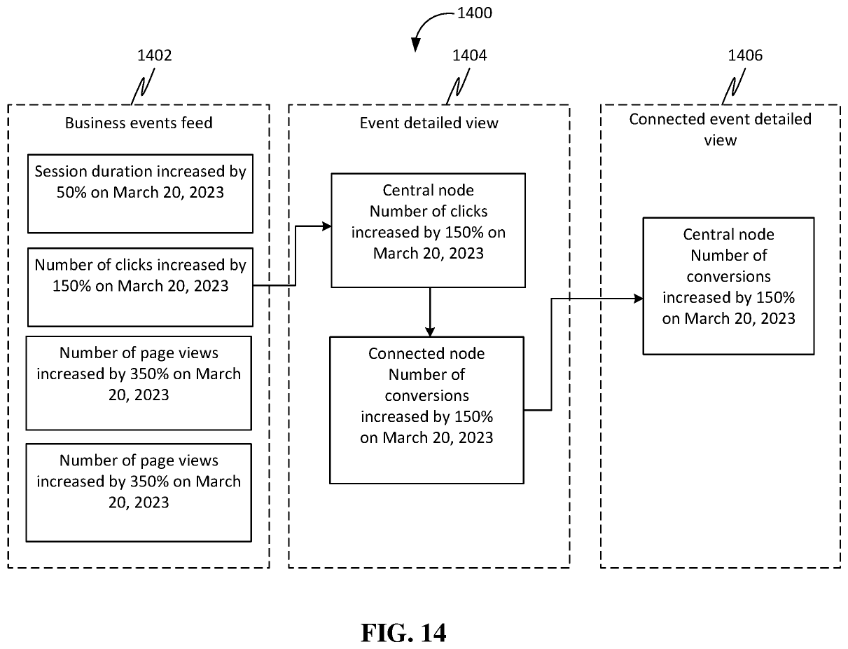

FIG. 14 is a schematic of a user interface (UI) layout 1400 for facilitating provisioning contexts for business situations, in accordance with some embodiments. Accordingly, the user interface layout 1400 may feature a main node view and a customizable feed. Further, the user interface layout 1400 may display a business events feed 1402, an event detailed view 1404, and a connected event detailed view 1406.

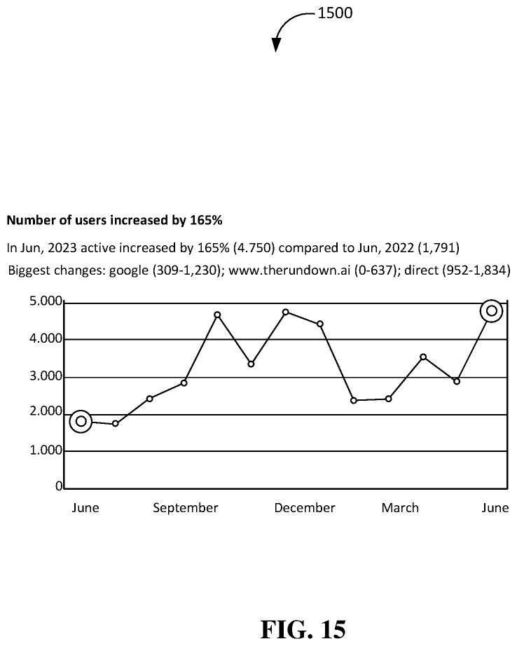

FIG. 15 is a screenshot of a user interface 1500 illustrating connection embeddings for facilitating provisioning contexts for business situations, in accordance with some embodiments. Accordingly, the user interface 1500 illustrates different ways of visualizing and interacting with the connections such as individual links, link lists, text embeddings, and chart embeddings. Further, in an embodiment, the user interface 1500 may display a business event text representation. Further, in an instance, the business event text representation may be “the number of clicks increased by 150% on Mar. 20, 2023”. Further, in an embodiment, the user interface 1500 may display direct text embedding. Further, in an instance, the direct text embedding may include “It was most likely caused by the 200% increase of ad impressions on Mar. 20, 2023”. Further, in an embodiment, the user interface 1500 may show an embedded link. Further, in an instance, the embedded link may be represented by “click here to see the consequences of this event”. Further, in an embodiment, the user interface 1500 may display link list embedding. Further, in an instance, the link list embedding may be “Click to drill-down by country:-United States-Germany-Japan”

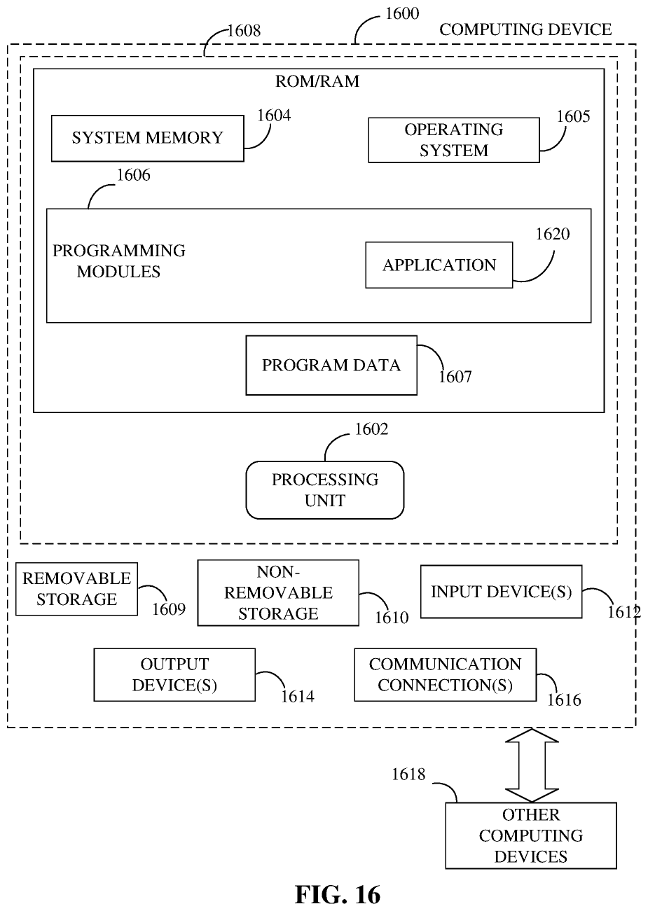

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g., random-access memory (RAM)), non-volatile (e.g., read-only memory (ROM)), flash memory, or any combination. System memory 1604 may include operating system 1605, one or more programming modules 1606, and may include a program data 1607. Operating system 1605, for example, may be suitable for controlling computing device 1600's operation. In one embodiment, programming modules 1606 may include image-processing module, machine learning module. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and non-volatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, a location sensor, a camera, a biometric sensor, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1604, including operating system 1605. While executing on processing unit 1602, programming modules 1606 (e.g., application 1620) may perform processes including, for example, one or more stages of methods, algorithms, systems, applications, servers, databases as described above. The aforementioned process is an example, and processing unit 1602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of facilitating provisioning contexts for business situations, the method comprising:
receiving, using a communication device, at least one business dataset associated with a business organization in real time from at least one device, wherein the at least one device may be at least one sensor, wherein the at least one sensor is configured for detecting at least one value of at least one of an internal condition and an external condition associated with the business organization in real time for generating the at least one business dataset;
analyzing, using a processing device, the at least one business dataset;
extracting, using the processing device, a plurality of business events from the at least one business dataset based on the analyzing of the at least one business dataset, wherein the plurality of business events is characterized by at least one business field;
analyzing, using the processing device, the plurality of business events;
determining, using the processing device, a plurality of business insights from the plurality of business events based on the analyzing of the plurality of business events;
analyzing, using the processing device, the plurality of business insights;
determining, using the processing device, at least one connection between at least two of the plurality of business insights based on the analyzing of the plurality of business insights, wherein the at least one connection links at least two of the plurality of business insights;
constructing, using the processing device, a semantic graph for providing a context for each of at least one business situation associated with the business organization based on the plurality of business insights and the at least one connection between at least two of the plurality of business insights, wherein the semantic graph represents each of the plurality of business insights as a node and each of the at least one connection as an edge linking at least two nodes of a plurality of nodes corresponding to the plurality of business insights, wherein the semantic graph provides the context for the business situation; and
storing, using a storage device, the semantic graph.

2. The method of claim 1 further comprising:
determining, using the processing device, at least one relation between at least two of the plurality of business insights based on the analyzing of the plurality of business insights; and
selecting, using the processing device, the at least one connection from a plurality of connections for at least two of the plurality of business insights based on the at least one relation, wherein the determining of the at least one connection between the at least two of the plurality of business insights is further based on the selecting.

3. The method of claim 1, wherein the analyzing of the plurality of business events comprises analyzing the plurality of business events using an event assessment algorithm, wherein the event assessment algorithm applies at least one predefined importance criteria for identifying the plurality of business insights from the plurality of business events, wherein the determining of the plurality of business insights is further based on the identifying.

4. The method of claim 1 further comprising determining, using the processing device, at least one additional connection between at least two of the plurality of business events based on the analyzing of the plurality of business events, wherein the at least one additional connection links at least two of the plurality of business events, wherein the plurality of business events further comprises the plurality of business insights, wherein the constructing of the semantic graph is further based on the plurality of business events and the at least one additional connection linking at least two of the plurality of business events, wherein the semantic graph further represents each of the plurality of business events as an additional node and each of the at least one additional connection as an additional edge linking at least two additional nodes of a plurality of additional nodes corresponding to the plurality of business events.

5. The method of claim 1 further comprising:
identifying, using the processing device, the at least one business situation associated with the business organization based on the analyzing of the at least one business dataset;
obtaining, using the processing device, at least one external data associated with the at least one business situation based on the identifying of the at least one business situation;
analyzing, using the processing device, the at least one external data;
extracting, using the processing device, at least one external event from the at least one external data based on the analyzing of the at least one external data;
analyzing, using the processing device, the at least one external event; and
determining, using the processing device, at least one external connection between the at least one external event and at least one of the plurality of business events based on the analyzing of the at least one external event, wherein the at least one external connection links the at least one external event and at least one of the plurality of business events, wherein the constructing of the semantic graph is further based on the at least one external event, at least one of the plurality of business events, and the at least one external connection linking the at least one external event and at least one of the plurality of business events, wherein the semantic graph further represents each of the at least one external event as an external node, at least one of the plurality of business events as an additional node, and each of the at least one external connection as an external edge linking at least one external node corresponding to the at least one external event and at least one of a plurality of additional nodes corresponding at least one of the plurality of business events.

6. The method of claim 1 further comprising:
visualizing, using the processing device, the semantic graph based on the generation of the semantic graph;
generating, using the processing device, an interactive visual representation of the semantic graph based on the visualizing, wherein the interactive visual representation allows exploring of the semantic graph; and
storing, using the storage device, the interactive visual representation.

7. The method of claim 6 further comprising:
receiving, using the communication device, at least one request from at least one user device associated with at least one user;
analyzing, using the processing device, the at least one request;
generating, using the processing device, at least one exploring parameter for the exploring of the semantic graph in at least one exploration session based on the analyzing of the at least one request;
generating, using the processing device, at least one view of the interactive visual representation of the semantic graph for the at least one exploration session based on the interactive visual representation and the at least one exploring parameter; and
transmitting, using the communication device, the at least one view to the at least one user device.

8. The method of claim 7 further comprising:
generating, using the processing device, at least one view data of the at least one view of the interactive visual representation of the semantic graph generated for the at least one exploration session based on the generating of the at least one view;
generating, using the processing device, at least one exploration path taken by the at least one user for the exploring of the interactive visual representation of the semantic graph during the at least one exploration session; and
storing, using the storage device, the at least one exploration path for the at least one exploration session.

9. The method of claim 8 further comprising:
retrieving, using the storage device, at least one historical exploration path taken by the at least one user for the exploring of the interactive visual representation of the semantic graph during at least one historical exploration session;
analyzing, using the processing device, the at least one historical exploration path;
generating, using the processing device, at least one recommendation for the exploring of the interactive visual representation of the semantic graph during the at least one exploration session;
transmitting, using the communication device, the at least one recommendation to the at least one user device;
receiving, using the communication device, at least one response corresponding to the at least one recommendation from the at least one user device; and
analyzing, using the processing device, the at least one response, wherein the generating of the at least one exploring parameter is further based on the analyzing of the at least one response.

10. The method of claim 7 further comprising:
identifying, using the processing device, the at least one user based on the analyzing of the at least one request; and
obtaining, using the processing device, at least one preference for the exploring of the interactive visual representation of the semantic graph of the at least one user based on the identifying of the at least one user, wherein the generating of the at least one exploring parameter is further based on the at least one preference.

11. A system of facilitating provisioning contexts for business situations, the system comprising:
a communication device configured for receiving at least one business dataset associated with a business organization in real time from at least one device, wherein the at least one device may be at least one sensor, wherein the at least one sensor is configured for detecting at least one value of at least one of an internal condition and an external condition associated with the business organization in real time for generating the at least one business dataset;
a processing device communicatively coupled with the communication device, wherein the processing device is configured for:
analyzing the at least one business dataset;
extracting a plurality of business events from the at least one business dataset based on the analyzing of the at least one business dataset, wherein the plurality of business events is characterized by at least one business field;
analyzing the plurality of business events;
determining a plurality of business insights from the plurality of business events based on the analyzing of the plurality of business events;
analyzing the plurality of business insights;
determining at least one connection between at least two of the plurality of business insights based on the analyzing of the plurality of business insights, wherein the at least one connection links at least two of the plurality of business insights; and
constructing a semantic graph for providing a context for each of at least one business situation associated with the business organization based on the plurality of business insights and the at least one connection between at least two of the plurality of business insights, wherein the semantic graph represents each of the plurality of business insights as a node and each of the at least one connection as an edge linking at least two nodes of a plurality of nodes corresponding to the plurality of business insights, wherein the semantic graph provides the context for the business situation; and
a storage device communicatively coupled with the processing device, wherein the storage device is configured for storing the semantic graph.

12. The system of claim 11, wherein the processing device is further configured for:
determining at least one relation between at least two of the plurality of business insights based on the analyzing of the plurality of business insights; and
selecting the at least one connection from a plurality of connections for at least two of the plurality of business insights based on the at least one relation, wherein the determining of the at least one connection between the at least two of the plurality of business insights is further based on the selecting.

13. The system of claim 11, wherein the analyzing of the plurality of business events comprises analyzing the plurality of business events using an event assessment algorithm, wherein the event assessment algorithm applies at least one predefined importance criteria for identifying the plurality of business insights from the plurality of business events, wherein the determining of the plurality of business insights is further based on the identifying.

14. The system of claim 11, wherein the processing device is further configured for determining at least one additional connection between at least two of the plurality of business events based on the analyzing of the plurality of business events, wherein the at least one additional connection links at least two of the plurality of business events, wherein the plurality of business events further comprises the plurality of business insights, wherein the constructing of the semantic graph is further based on the plurality of business events and the at least one additional connection linking at least two of the plurality of business events, wherein the semantic graph further represents each of the plurality of business events as an additional node and each of the at least one additional connection as an additional edge linking at least two additional nodes of a plurality of additional nodes corresponding to the plurality of business events.

15. The system of claim 11, wherein the processing device is further configured for:
identifying the at least one business situation associated with the business organization based on the analyzing of the at least one business dataset;
obtaining at least one external data associated with the at least one business situation based on the identifying of the at least one business situation;
analyzing the at least one external data;
extracting at least one external event from the at least one external data based on the analyzing of the at least one external data;
analyzing the at least one external event; and
determining at least one external connection between the at least one external event and at least one of the plurality of business events based on the analyzing of the at least one external event, wherein the at least one external connection links the at least one external event and at least one of the plurality of business events, wherein the constructing of the semantic graph is further based on the at least one external event, at least one of the plurality of business events, and the at least one external connection linking the at least one external event and at least one of the plurality of business events, wherein the semantic graph further represents each of the at least one external event as an external node, at least one of the plurality of business events as an additional node, and each of the at least one external connection as an external edge linking at least one external node corresponding to the at least one external event and at least one of a plurality of additional nodes corresponding at least one of the plurality of business events.

16. The system of claim 11, wherein the processing device is further configured for:
visualizing the semantic graph based on the generation of the semantic graph; and
generating an interactive visual representation of the semantic graph based on the visualizing, wherein the interactive visual representation allows exploring of the semantic graph, wherein the storage device is configured for storing the interactive visual representation.

17. The system of claim 16, wherein the communication device is configured for:
receiving at least one request from at least one user device associated with at least one user; and
transmitting at least one view to the at least one user device, wherein the processing device is further configured for:
analyzing the at least one request;
generating at least one exploring parameter for the exploring of the semantic graph in at least one exploration session based on the analyzing of the at least one request; and
generating the at least one view of the interactive visual representation of the semantic graph for the at least one exploration session based on the interactive visual representation and the at least one exploring parameter.

18. The system of claim 17, wherein the processing device is further configured for:
generating at least one view data of the at least one view of the interactive visual representation of the semantic graph generated for the at least one exploration session based on the generating of the at least one view; and
generating at least one exploration path taken by the at least one user for the exploring of the interactive visual representation of the semantic graph during the at least one exploration session, wherein the storage device is further configured for storing the at least one exploration path for the at least one exploration session.

19. The system of claim 18, wherein the storage device is further configured for retrieving at least one historical exploration path taken by the at least one user for the exploring of the interactive visual representation of the semantic graph during at least one historical exploration session, wherein the processing device is further configured for:
analyzing the at least one historical exploration path;
generating at least one recommendation for the exploring of the interactive visual representation of the semantic graph during the at least one exploration session; and
analyzing at least one response, wherein the generating of the at least one exploring parameter is further based on the analyzing of the at least one response, wherein the communication device is further configured for:
transmitting the at least one recommendation to the at least one user device; and
receiving the at least one response corresponding to the at least one recommendation from the at least one user device.

20. The system of claim 17, wherein the processing device is further configured for:
identifying the at least one user based on the analyzing of the at least one request; and
obtaining at least one preference for the exploring of the interactive visual representation of the semantic graph of the at least one user based on the identifying of the at least one user, wherein the generating of the at least one exploring parameter is further based on the at least one preference.
